(19) United States
(12) Patent Application Publication
(10) Pub. No.: US 2006/0071071 A1
(43) Pub. Date: Apr. 6, 2006

(54) Methods and systems for providing a tracking indicia for an item

(76) Inventor: Vantresa Stickler, Annapolis, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/142,231

(22) Filed: Jun. 2, 2005

Related U.S. Application Data
(60) Provisional application No. 60/576,862, filed on Jun. 3, 2004.

(51) Int. Cl. G06Q 30/00

(52) U.S. Cl. 235/385

(57) ABSTRACT

Systems and methods for providing a tracking indicia may comprise receiving a request to receive the tracking indicia, the request being received from a sender of an item. Furthermore, systems and methods for providing a tracking indicia may comprise providing the tracking indicia, the tracking indicia being configured to be applied to the item by the sender. Moreover, systems and methods for providing a tracking indicia may comprise tracking the item as it passes through an item delivery system and providing data to the sender corresponding to the item's passage through the item delivery system.

### BACKGROUND

This application claims priority to U.S. Provisional Application No. 60/576,862, filed on Jun. 3, 2004, the contents of which are expressly incorporated herein by reference.

1. Technical Field

The present invention generally relates to providing a tracking indicia for an item. More particularly, the present invention relates to providing a tracking indicia for an item that may be initiated or applied by an item's sender.

2. Background of the Invention

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages and other items.

Item delivery systems process and deliver billions of items each year. In this large-scale item delivery system, tracking items sent is an important feature. Consequently, providing tracking indicia for items is desired. Especially in the environments of electronic commerce and electronic shipping, inefficiencies are created in conventional tracking indicia providing systems because, for example, they do not allow a sender to easily obtain and apply the tracking indicia. Accordingly, providing a tracking indicia remains an elusive goal. Thus, there remains a need for efficiently providing a tracking indicia. In addition, there remains a need for efficiently providing a tracking indicia that may be initiated and/or applied to the item by the item's sender.

### SUMMARY OF THE INVENTION

Consistent with embodiments of the present invention, systems and methods are disclosed for providing a tracking indicia for an item.

In accordance with one embodiment, a method for providing a tracking indicia comprises receiving a request to receive the tracking indicia, the request being received from a sender of an item, providing the tracking indicia, the tracking indicia being configured to be applied to the item by the sender, tracking the item as it passes through an item delivery system, and providing data to the sender corresponding to the item's passage through the item delivery system.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary item delivery system consistent with an embodiment of the present invention.

FIG. 2 is a flow chart of an exemplary method for providing a tracking indicia consistent with an embodiment of the present invention.

FIG. 3 is a block diagram of an exemplary tracking indicia system consistent with an embodiment of the present invention.

FIG. 4 is a block diagram of an exemplary user computer and printer consistent with certain embodiments of the present invention.

FIG. 5 shows an exemplary indicia including tracking information consistent with certain embodiments of the present invention.

FIG. 6 shows an exemplary sheet having self adhesive peel-off indicia consistent with certain embodiments of the present invention

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with the invention may provide a tracking indicia. Indicia in this context refers to both the singular and the plural. Furthermore, the systems and methods may track an item using the provided tracking indicia and may provide tracking data regarding the item's movement through a delivery system. For example, an embodiment of the invention may provide tracking indicia (for example, 2-D codes, 4-state, or planet code symbologies) by selling barcoded strips via a retail counter.

Embodiments might find particular use in electronic commerce, electronic postage, and electronic shipping.

The tracking indicia may be printed and presented to a user, for example, in the same manner that postage stamps are sold. A number of individual tracking indicia may be produced and provided in a sheet or book. The tracking indicia may be printed in a label strip fashion and may be a peeled off to expose an adhesive on the label strip's back. Accordingly, the tracking indicia may be self adhesive and may be applied to an envelope similar to the way a postage stamp may be applied. Through peeling off and applying an adhesive tracking indicia to an item, a delivery system operator may offer the user tracking data regarding the item's movement and delivery through a delivery system. For example, the delivery system operator may provide the aforementioned information via e-mail.

Furthermore, the user may manifest a desire to obtain and subsequently receive the tracking indicia via a network such as the Internet. For example, the user may provide the delivery system operator over the network delivery data such as: i) the item's desired destination; ii) the size and weight of the item; iii) a desire to have the item tracked as it passes through the delivery system and is ultimately delivered; and iv) payment information (for example a credit card or checking account number.) In addition, the delivery system operator may provide data over the network sufficient for the user to create a label for the item. For example, the delivery system operator may provide to a computer operated by the user, data sufficient for the user computer to create and print out a label for the item. The label may contain the tracking indicia and any other information that the delivery system operator may use to track the item as it passes through the delivery system and to its ultimate delivery point. Using the payment information, the delivery system operator may charge the user a fee for tracking the item, providing the user tracking data, and for delivering the item. The tracking indicia indicates satisfaction of the fee, such as a proof of purchase, proof of credit extended, or promise to pay.

Consistent with embodiments of the invention, a delivery point may be a physical place to which a delivery system operator may deliver an item. A delivery point may be, for example, a street letterbox, a door slot, an apartment building box cluster, or a separate post office box. The aforementioned are exemplary, and delivery points may comprise any location where an item may be received. Furthermore, an item may comprise a mailpiece, a United States Postal Service Priority Mail package, a United States Postal Service Express Mail Package, or any other item to be delivered. The aforementioned are exemplary and the item may comprise any deliverable element.

An embodiment consistent with the invention may comprise a system for providing a tracking indicia. The system may comprise a memory storage for maintaining a database and a processing unit coupled to the memory storage. The processing unit may be operative to receive a request to receive the tracking indicia, the request being received from a sender of an item. Furthermore, the processing unit may be operative to provide the tracking indicia, the tracking indicia being configured to be applied to the item by the sender. Moreover, the processing unit may be operative to track the item as it passes through an item delivery system and to provide data to the sender corresponding to the item's passage through the item delivery system.

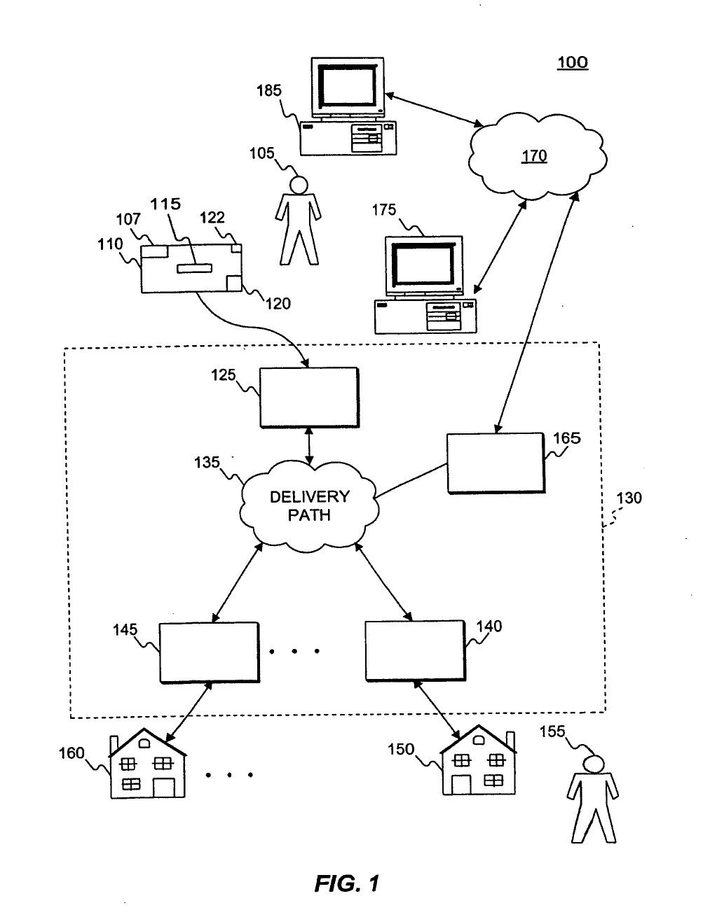

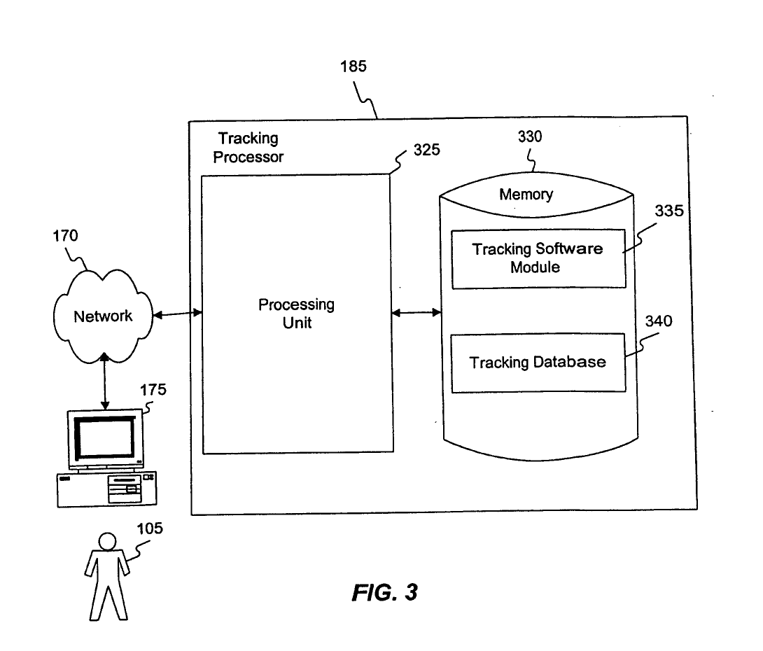

Consistent with an embodiment of the present invention, the aforementioned memory, processing unit, and other components may be implemented in a tracking indicia system, such as an exemplary tracking indicia system 100 of FIG. 1. Any suitable combination of hardware, software and/or firmware may be used to implement the memory, processing unit, or other components. By way of example, the memory, processing unit, or other components may be implemented with any of a user processor 175 or a tracking processor 185, in combination with system 100, as described below with respect to FIG. 1 and FIG. 3. The aforementioned system and processors are exemplary and other systems and processors may comprise the aforementioned memory, processing unit, or other components, consistent with embodiments of the present invention.

Furthermore, any system or component of the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

By way of a non-limiting example, FIG. 1 illustrates item delivery system 100 in which the features and principles of the present invention may be implemented. For example, a user 105 may place an item 110 into a delivery system 130. Item 110 may contain a label 115 indicating a first address 150 of a recipient 155 and a return address 107 indicating where to return item 110 if necessary. Item 110 may include a postage stamp 122. Item 110 may also contain a tracking indicia 120 relating to, for example, user 105 and recipient 155. Tracking indicia 120 may be placed on item 110 by user 105 or the operator of delivery system 130.

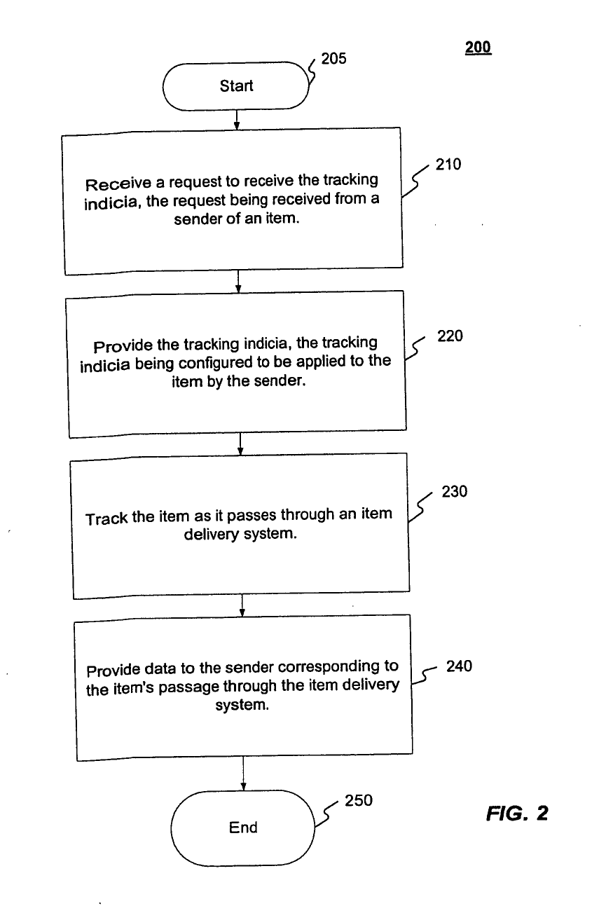

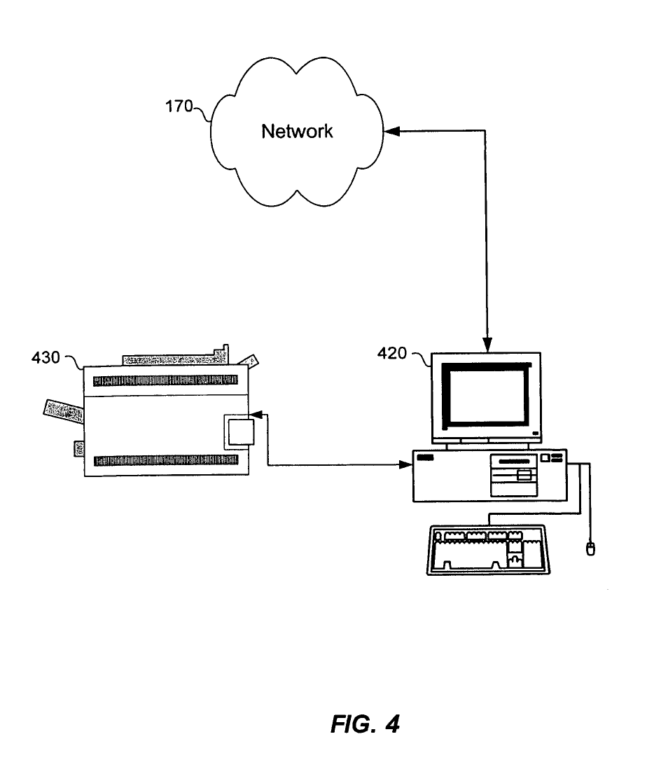

Tracking indicia 120 may be requested, received, and applied to item 110 as described below with respect to FIG. 2, FIG. 3, and FIG. 4. User 105 may be, for example, an individual needing to receive a tracking indicia and to receive tracking data regarding an item's movement through a delivery system. User 105 may also be an organization, enterprise, or any other entity having such needs.

Some or all of the information on the item 110, such as the label 115, the return address 107, the tracking indicia 120, and the postage stamp 122, may be combined into a single indicia. Thus, the tracking indicia 120, in addition to tracking information, might also include one or more of the label 115, the return address 107, and the postage stamp 122.

Item 110 may be routed through delivery system 130, which may comprise a plurality of facilities, including a sender plant 125, a delivery path 135, a first address plant 140, an alternative address plant 145, and an alternative processing point 165. Delivery system 130 may comprise a plurality of plants similar to sender plant 125, first address plant 140, and alternative address plant 145. The plants within delivery system 130 may contain, among other things, scanning equipment designed to scan and read tracking indicia on items processed by plants within delivery system 130. For example, delivery system 130 may be configured to sense tracking indicia 120 on item 110 with the scanning equipment as item 110 passes through the elements of delivery system 130. Accordingly, delivery system 130 may collect tracking data corresponding to movement of item 110 through delivery system 130 and provide this tracking data to processor 185, for example. System 100 may also include a network 170 as described in more detail below with respect to FIG. 3. Any or all of the systems or components of system 100 may communicate using network 170. For example, elements of delivery system 130 may provide the tracking data to processor 185 over network 170.

Tracking indicia 120 may comprise a PLANET code, to be described below. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, delivery system operators sorted flat mail using POSTNET, a 12-digit barcode consisting of alternating long and short bars indicating the destination of, for example, a mailpiece. Responding to the expanding needs of users who are particularly heavy volume users, PLANET code was developed on the foundation of the existing technical infrastructure. The PLANET code is the opposite of the POSTNET code, reversing long bars for short and short bars for long. This innovation offers the convenience of a bar code that is easily applied using current bar-coding methods, and is readily scanned by the high-speed automation equipment located in the plurality of plants comprising delivery system 130. PLANET codes or any advanced symbology can house information regarding the services applied to an item such as a mailpiece, for example.

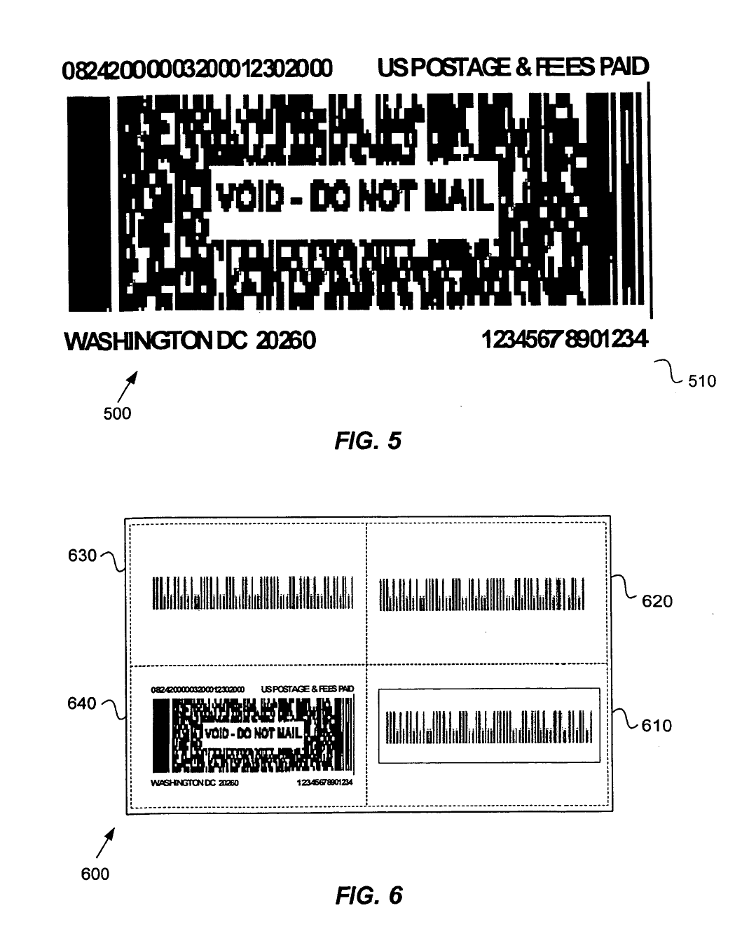

FIG. 5 shows an example of 2-D barcode 500. In addition to the machine readable tracking information, a human readable tracking number 510 may be printed in the lower right side of the barcode 500. Any human readable information may be placed at any location around the machine readable barcode. For example, a tracking number 510 or any other postage information may be printed in the lower right corner.

FIG. 6 shows an example of sheet 600 having self adhesive peel-off indicia 610, 620, 630, 640. The sheet 600 includes a substrate, such as a paper or cardboard backing, and a plurality of the self-adhesive labels temporarily attached to the substrate. A user peels the labels off the substrate and applies the labels to an item such as an envelope, a mail piece, or a package. In this example, the sheet 600 includes peel-off tracking indicia 640, peel-off planet code label 610, and peel-off planet code stamp indicia 620, 630. Off course, several such peel-off indicia could be provided on one sheet.

Item 110 may be sent through delivery system 130 by user 105 to first address plant 140. At any time in the delivery process, a determination may be made as to whether item 110 is undeliverable (including undeliverable-as-addressed.) If it is determined that item 110 is undeliverable-as-addressed, item 110 may be forwarded to alternative processing point 165 where an ancillary service may be performed. Examples of such ancillary services may include recycle service (treating item 110 as waste), “NIXIE” service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 110 is undeliverable-as-addressed, address correction service (re-label with a correct address) or return service (return item to the sender) may be performed. In this case, a NIXIE operator specialized in the handling of such items may be required. If item 110 requires return service, return address 115 on item 110 may be read and item 110 may be sent to return address 107 accordingly. Return address 107 may be an element of item 110 that is usually placed in the upper left corner of item 110 to indicate the address of user 105. This address may indicate where user 105 may want item 110 returned if it is undeliverable (including undeliverable-as-addressed.) In addition return address 107 may indicate where user 105 may receive a bill for any fees due for the return of item 110. When item 110 requires address correction service, a NIXIE operator may obtain the proper address of recipient 155 or the reason for non-delivery. While NIXIE processing may comprise address correction service or return service, other types of NIXIE processing may be performed.

Computerized forwarding service may be a centralized, computerized address label-generating operation that forwards undeliverable-as-addressed items to recipients. In this case, recipient 155 may pre-register an alternative address 160 of recipient 155 with the delivery system operator in order to have all items forwarded to alternative address 160. For example, if recipient 155 moves and wishes to have items sent to alternative address 160, recipient 155 may notify the delivery system operator of alternative address 160. Once the delivery system operator is notified of alternative address 160, all items sent to first address 150 may be detected by delivery system 130, re-labeled, and then forwarded to alternative address 160. In the aforementioned computerized forwarding service, items may be forwarded only for a specific period of time, thus providing recipient 155 time to contact each and every sender who recipient 155 may expect to send an item and notify the possible senders of the address change of recipient 155. After the computerized forwarding service time period is complete, the delivery system operator may cease forwarding items to recipient 155 and may return to the user 105 all items sent to first address 150.

If ancillary services were required, item 110 may remain at alternative processing point 165 or may be processed at an item recovery section of alternative processing point 165. Item 110 may be recovered by user 105 or recipient 155 upon the completion of a “tracer.” A tracer is a paper or electronic form completed by user 105 or recipient 155 to locate delayed or undelivered items (including items undeliverable-as-addressed.) While item recovery may occur at alternative processing point 165, other types of processing may be performed at alternative processing point 165.

While tracking processor 185 is shown to be separate from delivery system 130, the functionality of tracking processor 185 may be performed under the control of the delivery system operator at alternative processing point 165, at any point within delivery system 130, or at any point outside delivery system 130. Moreover, the functionality of tracking processor 185 may be performed by an enterprise not under the control of the delivery system operator. Moreover, the delivery system operator may communicate over network 170 with user processor 175 operated by user 105.

FIG. 2 is a flow chart setting forth the general stages involved in an exemplary method 200 consistent with the invention for providing a tracking indicia using system 100 of FIG. 1. Exemplary ways to implement the stages of exemplary method 200 will be described in greater detail below. Exemplary method 200 may begin at starting block 205 and proceed to stage 210 where processor 185 may receive a request to receive a tracking indicia 120. The request may be received from a sender of item 110, for example, user 105. For example, if the delivery system operator comprises the USPS, user 105 may request tracking indicia 120 at a post office operated by the USPS or any retail counter or vending machine offering such tracking indicia. Furthermore, user 105, using processor 175, may request tracking indicia 120 over network 170 by sending a request for tracking indicia 120 to tracking processor 185.

From stage 210 where processor 185 receives the request to receive tracking indicia 120, exemplary method 200 may then proceed to stage 220 where processor 185 may provide tracking indicia 120. Tracking indicia 120 may be configured to be applied to item 110 by the sender. For example, user 105 may receive tracking indicia 120 at a post office operated by the USPS or any retail counter or vending machine offering such tracking indicia. Furthermore, user 105, using processor 175, may receive tracking indicia 120 over network 120 from tracking processor 185. Tracking indicia 120 may be printed and presented to user 105, for example, in the same manner that stamps are sold. A number of individual tracking indicia may be produced and provided in a sheet or book. Tracking indicia 120 may be printed in a label strip fashion and may be a peeled off to expose an adhesive on the label strip's back. Accordingly, tracking indicia 120 may be self-adhesive and may be applied to item 110 similar to the way a postage stamp may be applied, such as postage stamp 122.

Alternatively, user 105 may provide delivery data to the delivery system operator over network 170. The delivery data may include data such as the item 110's desired destination, the size and weight of item 110, a desire to have item 110 traced as it passes through delivery system 130 and is ultimately delivered, and payment information (for example a credit card or checking account number). In return, the delivery system operator may provide data to processor 175, over network 170, sufficient to create tracking indicia 120 or a label for item 110 including tracking indicia 120. The label may contain tracking indicia 120 as well as other information that the delivery system operator may use to track item 110 as it passes through delivery system 130 and to its ultimate delivery point such as first address 150. Using the payment information, the delivery system operator may charge a fee to user 105 for the services of tracking, providing user 105 tracking information, and for delivering item 110.

As shown in the block diagram of FIG. 4, a user computer 420 may send information to the network 170 and may receive information from the network 170. Processing information from the network 170, the computer 420 may format data to create a tracking indicia 120 and may direct a printer 430. The printer 430 may then print the tracking indicia 120, and the user applies the tracking indicia 120 to a mailpiece or a package.

Once processor 185 provides tracking indicia 120 in stage 220, exemplary method 200 may continue to stage 230 where processor 185 may track item 110 as it passes through item delivery system 130. For example, as described above; delivery system 130 may be configured to sense tracking indicia 120 on item 110 with scanning equipment as item 110 passes through the elements of delivery system 130. Accordingly, delivery system 130 may collect tracking data corresponding to item 110's movement through delivery system 130 and provide the tracking data to processor 185, for example. Elements of delivery system 130 may provide the tracking data to processor 185 over network 170.

Next, exemplary method 200 may advance to stage 240 where processor 185 may provide data to user 105 corresponding to item 110's passage through item delivery system 130. For example, tracking processor 185 may provide the tracking data to user processor 175 over network 170. From stage 210 where processor 185 provides data to user 105 corresponding to the item 110's passage through item delivery system 130, exemplary method 200 may end at stage 250.

As shown in FIG. 3, tracking processor 185 may comprise a memory storage for maintaining a database and a processing unit coupled to the memory storage. The memory, processing unit, or other components of system 185 may be implemented in combination with system 100. The aforementioned system and processor are exemplary and other systems and processors may comprise the aforementioned memory, processing unit, or other components, consistent with embodiments of the present invention.

As illustrated in the block diagram of FIG. 3, system 100 includes a tracking processor 185 which may include a processing unit 325 and a memory 330. Memory 330 may include a tracking software module 335 and a tracking database 340. For example, tracking software module 335, executed on processing unit 325, may access tracking database 340 and implement processes for providing a tracking indicia such as the method described above with respect to FIG. 2.

Processor 175, processor 185, or any other processor or component included in system 100 (“the processors”), may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 170 may comprise, for example, a local area network (LAN), a wide area network (WAN), a wireless wide area network (WWAN), or a wireless local area network (WLAN). Such networking environments are commonplace in offices, enterprise-wide computer networks, intranets, and the Internet, and are known by those skilled in the art. When a LAN is used as network 170, a network interface located at any of the processors may be used to interconnect any of the processors. When network 170 is implemented in a WAN networking environment, such as the Internet, the processors may typically include an internal or external modem (not shown) or other means for establishing communications over the WAN. Further, in utilizing network 170, data sent over network 170 may be encrypted to insure data security by using known encryption/decryption techniques.

In addition to utilizing a wire line communications, a wireless communications system or a combination of wire line and wireless may be utilized as network 170 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit data by methods and processes other than, or in combination with, network 170. These methods and processes may include, but are not limited to, transferring data via, diskette, CD ROM, flash memory sticks, facsimile, conventional mail, an interactive voice response system (IVR), or via voice over a publicly switched telephone network.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing a tracking indicia for an item to be sent through an item delivery system from a sender to a receiver, the tracking indicia being for tracking the item through the item delivery system, the method comprising:
receiving in a processor a request to receive the tracking indicia, the request being from the sender of an item;
processing in the processor data for generating the tracking indicia; and
providing the tracking indicia to the sender, the tracking indicia being configured to be applied to the item by the sender.

2. The method of claim 1, further comprising:
tracking the item as it passes through the item delivery system; and
providing data to the sender corresponding to the item's passage through the item delivery system.

3. The method of claim 1, wherein the step of providing the tracking indicia includes printing the tracking indicia on a recording medium.

4. The method of claim 3, wherein the recording medium comprises a peel-off self-adhesive label.

5. The method of claim 4, wherein the recording medium comprises a plurality of peel-off self-adhesive labels and wherein a plurality of tracking indicia are printed on the recording medium.

6. The method of claim 1, wherein the tracking indicia comprises a machine readable code.

7. The method of claim 6, wherein the tracking indicia comprises a 2-D code.

8. The method of claim 6, wherein the tracking indicia comprises a 4-state code.

9. The method of claim 6, wherein the tracking indicia comprises a PLANET code.

10. The method of claim 1, wherein the step of providing the tracking indicia to the sender comprises providing the tracking indicia to the sender at a retail counter.

11. The method of claim 5, wherein the step of providing the tracking indicia to the sender comprises providing the tracking indicia to the sender at a retail counter.

12. The method of claim 1, wherein the tracking indicia indicates satisfaction of a delivery fee.

13. The method of claim 5, wherein the tracking indicia indicates satisfaction of a delivery fee.

14. An apparatus for providing a tracking indicia for an item to be sent through an item delivery system from a sender to a receiver, the tracking indicia being for tracking the item through the item delivery system, comprising:
means for receiving a request to receive the tracking indicia, the request being received from the sender of an item;
means for processing data for generating the tracking indicia;
means for transmitting the data for generating the tracking indicia; and
means for providing the tracking indicia to the sender based on the transmitted data for generating the tracking indicia, the tracking indicia being configured to be applied to the item by the sender.

15. The apparatus of claim 14, wherein the means for providing the tracking indicia comprises a printer for printing the tracking indicia on a recording medium.

16. The apparatus of claim 15, wherein the recording medium comprises a peel-off self-adhesive label.

17. The apparatus of claim 16, wherein the recording medium comprises a plurality of peel-off self-adhesive labels and wherein a plurality of tracking indicia are printed on the recording medium.

18. The apparatus of claim 14, wherein the means for transmitting comprises a network.

19. The apparatus of claim 18, wherein the network comprises a wireless network.

20. The apparatus of claim 18, wherein the network comprises the Internet.

21. The apparatus of claim 14, further comprising:
means for tracking the item as it passes through the item delivery system; and
means for providing data to the sender corresponding to the item's passage through the item delivery system.

22. The apparatus of claim 21, wherein the means for providing comprises the Internet.

23. The apparatus of claim 14, wherein the tracking indicia indicates satisfaction of a delivery fee.

24. A computer readable medium having contents for causing a computer-based information handling system to perform steps for providing a tracking indicia for an item to be sent through an item delivery system from a sender to a receiver, the tracking indicia being for tracking the item through the item delivery system, the steps comprising:
receiving a request to receive the tracking indicia, the request being received from the sender of an item; and
providing the tracking indicia to the sender, the tracking indicia being configured to be applied to the item by the sender.

25. The computer readable medium of claim 24, wherein the tracking indicia indicates satisfaction of a delivery fee.

26. A plurality of tracking indicia, the tracking indicia being configured to be applied to items by the sender, the items to be sent through an item delivery system from a sender to a receiver, the tracking indicia being for tracking the items through the item delivery system, the plurality of tracking indicia comprising:
a substrate; and
a plurality of peel-off self-adhesive labels on the substrate, a tracking indicia code being on the peel-off self-adhesive labels.

27. The tracking indicia of claim 26, wherein the tracking indicia indicates satisfaction of a delivery fee.

28. The method of claim 26, wherein the tracking indicia comprises a machine readable code.

29. The method of claim 26, wherein the tracking indicia comprises a 2-D code.

30. The method of claim 26, wherein the tracking indicia comprises a 4-state code.

31. The method of claim 26, wherein the tracking indicia comprises a PLANET code.
